(19) United States
(12) Patent Application Publication
(10) Pub. No.: US 2025/0229112 A1
(43) Pub. Date: Jul. 17, 2025

(54) IN-GROUND RACEWAY OF A SAFETY SYSTEM ASSOCIATED WITH A STRUCTURE WITH ONE OR MORE FIRE RATED COMPONENT(S) TO PROVIDE PHYSICAL ISOLATION AND TO SEAMLESSLY AND JOINTLESSLY TRANSITION A METALLIC COIL TUBE ACROSS PERPENDICULAR DIRECTIONS

(71) Applicant: RESCUE AIR SYSTEMS, INC., San Carlos, CA (US)

(72) Inventor: Anthony J. Turiello, Westlake, TX (US)

(73) Assignee: RESCUE AIR SYSTEMS, INC., San Carlos, CA (US)

(21) Appl. No.: 18/854,679

(22) PCT Filed: Jun. 28, 2023
(86) PCT No.: PCT/US2023/026466

§ 371 Date: Oct. 7, 2024

Related U.S. Application Data
(60) Provisional application No. 63/356,996, filed on Jun. 29, 2022.

(51) Int. Cl. A62B 15/00; F16L 3/26

(52) U.S. Cl. CPC A62B 15/00; F16L 3/26

(57) ABSTRACT

A raceway includes a horizontal sleeve element carrying a metallic coil tube therethrough below a ground level associated with a structure such that the horizontal sleeve element is directly embedded in a base layer under the ground level and immediately below a first layer of the ground level. and a curved elbow element directly connected to the horizontal sleeve element at each of both ends of the horizontal sleeve element to transition the metallic coil tube across perpendicular directions. The raceway establishes a pathway for an electrical and/or a breathable air connection between components of a safety system implemented within the structure based on seamlessly and jointlessly drawing the metallic coil tube out of the curved elbow element on the each of both the ends of the horizontal sleeve element. Components of the raceway create a fire rated enclosure for the metallic coil tube.

### CLAIM OF PRIORITY

This Application is a conversion application of, and claims priority to. U.S. Provisional Patent Application No. 63/356,996 titled CLOUD-BASED FIREFIGHTING AIR REPLENISHMENT MONITORING SYSTEM, SENSORS AND METHODS filed on Jun. 29, 2022. The contents of the aforementioned application are incorporated herein by reference in entirety thereof.

### FIELD OF TECHNOLOGY

This disclosure relates generally to emergency systems and, more particularly. to a system, a device and/or a method of an in-ground raceway of a safety system associated with a structure with one or more fire rated component(s) to provide physical isolation and to seamlessly and jointlessly transition a metallic coil tube across perpendicular directions.

### BACKGROUND

A structure (e.g., a vertical building, a horizontal building, a tunnel, marine craft) may have a Firefighter Air Replenishment System (FARS) implemented therein. The structure may have an emergency air fill station therein to enable firefighters and/or emergency personnel inhale safe air through face-pieces of respirators or Self-Contained Breathing Apparatuses (SCBAs). The structure may also include electrical connections and/or air connections between components (e.g., including the emergency air fill station) of the FARS. Unstructured and/or poorly designed electrical and/or air connections may render elements thereof vulnerable to corrosive forces and/or emergency forces within an environment of said connections. Moreover, emergency personnel utilizing the FARS may also be exposed to risks associated with the vulnerable elements.

### SUMMARY

Disclosed are a system, a device and/or a method of an in-ground raceway of a safety system associated with a structure with one or more fire rated component(s) to provide physical isolation and to seamlessly and jointlessly transition a metallic coil tube across perpendicular directions.

In one aspect, a raceway includes a horizontal sleeve element carrying a metallic coil tube therethrough below a ground level associated with a structure such that the horizontal sleeve element is directly embedded in a base layer under the ground level and immediately below a first layer of the ground level, a curved elbow element directly connected to the horizontal sleeve element at each of both ends of the horizontal sleeve element to transition the metallic coil tube from a first direction thereof parallel to the ground level to a second direction thereof perpendicular to the ground level, and a female adapter element provided at an end of the curved elbow element along the second direction to receive the end of the curved elbow element directly therewithin.

The raceway also includes a bushing element directly connected to the female adapter element, and a male connector element bored into the bushing element. The metallic coil tube passes through the male connector element and the bushing element. In accordance with compression based fitting, the metallic coil tube is sealed to a stable position thereof within the male connector element proximate the end of the curved elbow element in accordance with one or more ferrule element(s) encircling the metallic coil tube gripping an outer surface of the metallic coil tube as a result of a compression element also receiving the metallic coil tube therethrough locking on to the male connector element.

A pathway for an electrical and/or a breathable air connection between a first component of a safety system implemented within the structure and a second component thereof is established based on seamlessly and jointlessly drawing the metallic coil tube out of the curved elbow element on the each of both the ends of the horizontal sleeve element based on the stable position of the metallic coil tube maintained in the second direction. At least the horizontal sleeve element, the curved elbow element and the female adapter element create a fire rated enclosure for the metallic coil tube.

In another aspect, a raceway system associated with a structure includes a first component of a safety system implemented in the structure, a second component of the safety system implemented in the structure, and a raceway. The raceway includes a horizontal sleeve element carrying a metallic coil tube therethrough below a ground level associated with the structure such that the horizontal sleeve element is directly embedded in a base layer under the ground level and immediately below a first layer of the ground level, a curved elbow element directly connected to the horizontal sleeve element at each of both ends of the horizontal sleeve element to transition the metallic coil tube from a first direction thereof parallel to the ground level to a second direction thereof perpendicular to the ground level, and a female adapter element provided at an end of the curved elbow element along the second direction to receive the end of the curved elbow element directly therewithin.

The raceway also includes a bushing element directly connected to the female adapter element, and a male connector element bored into the bushing element. The metallic coil tube passes through the male connector element and the bushing element. In accordance with compression based fitting, the metallic coil tube is sealed to a stable position thereof within the male connector element proximate the end of the curved elbow element in accordance with one or more ferrule element(s) encircling the metallic coil tube gripping an outer surface of the metallic coil tube as a result of a compression element also receiving the metallic coil tube therethrough locking on to the male connector element.

A pathway for an electrical and/or a breathable air connection between the first component of the safety system and the second component thereof is established based on seamlessly and jointlessly drawing the metallic coil tube out of the curved elbow element on the each of both the ends of the horizontal sleeve element based on the stable position of the metallic coil tube maintained in the second direction. At least the horizontal sleeve element, the curved elbow element and the female adapter element create a fire rated enclosure for the metallic coil tube.

In yet another aspect, a method includes embedding a horizontal sleeve element carrying a metallic coil tube therethrough below a ground level associated with a structure such that the horizontal sleeve element is directly embedded in a base layer under the ground level and immediately below a first layer of the ground level, and transitioning the metallic coil tube from a first direction thereof parallel to the ground level to a second direction thereof perpendicular to the ground level based on directly connecting a curved elbow element to the horizontal sleeve element at each of both ends of the horizontal sleeve element. The transition of the metallic coil tube is based on providing a female adapter element at an end of the curved elbow element along the second direction by way of receiving the end of the curved elbow element directly within the female adapter element, providing a bushing element directly coupled to the female adapter element, boring a male connector element into the bushing element, and passing the metallic coil tube through the male connector element and the bushing element.

The transition of the metallic coil also involves, based on compression based fitting, sealing the metallic coil tube to a stable position thereof within the male connector element proximate the end of the curved elbow element in accordance with one or more ferrule element(s) encircling the metallic coil tube gripping an outer surface of the metallic coil tube as a result of a compression element also receiving the metallic coil tube therethrough locking on to the male connector element. The method also includes providing a pathway for an electrical and/or a breathable air connection between a first component of a safety system implemented within the structure and a second component thereof based on seamlessly and jointlessly drawing the metallic coil tube out of the curved elbow element on the each of both the ends of the horizontal sleeve element based on the stable position of the metallic coil tube maintained in the second direction, and providing a fire rated enclosure for the metallic coil tube at least based on providing the horizontal sleeve element, the curved elbow element and the female adapter element therefor.

Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of a safety system associated with a structure, according to one or more embodiments.

FIG. 2 is a schematic view of a raceway embedded within a ground level associated with a structure associated with the safety system of FIG. 1, according to one or more embodiments.

FIG. 3 is a schematic view of a transition element of the raceway of FIG. 2 in detail, according to one or more embodiments.

FIG. 4 is a schematic view of a compression mechanism based on which an outer surface of a metallic coil tube of the raceway of FIG. 2 or a metallic coil tube of FIG. 3 is sealed into a stable position thereof, according to one or more embodiments.

FIG. 5 is a schematic view of a metallic coil tube wound onto a spool, according to one or more embodiments.

FIG. 6 is a process flow diagram detailing the operations involved in realizing an in-ground raceway of a safety system associated with a structure with one or more fire rated component(s) to provide physical isolation and to seamlessly and jointlessly transition a metallic coil tube across perpendicular directions, according to one or more embodiments.

Other features of the present embodiments will be apparent from the accompanying drawings and from the detailed description that follows.

### DETAILED DESCRIPTION

Example embodiments, as described below, may be used to provide a system, a device and/or a method of an in-ground raceway of a safety system associated with a structure with one or more fire rated component(s) to provide physical isolation and to seamlessly and jointlessly transition a metallic coil tube across perpendicular directions. Although the present embodiments have been described with reference to specific example embodiments, it will be evident that various modifications and changes may be made to these embodiments without departing from the broader spirit and scope of the various embodiments.

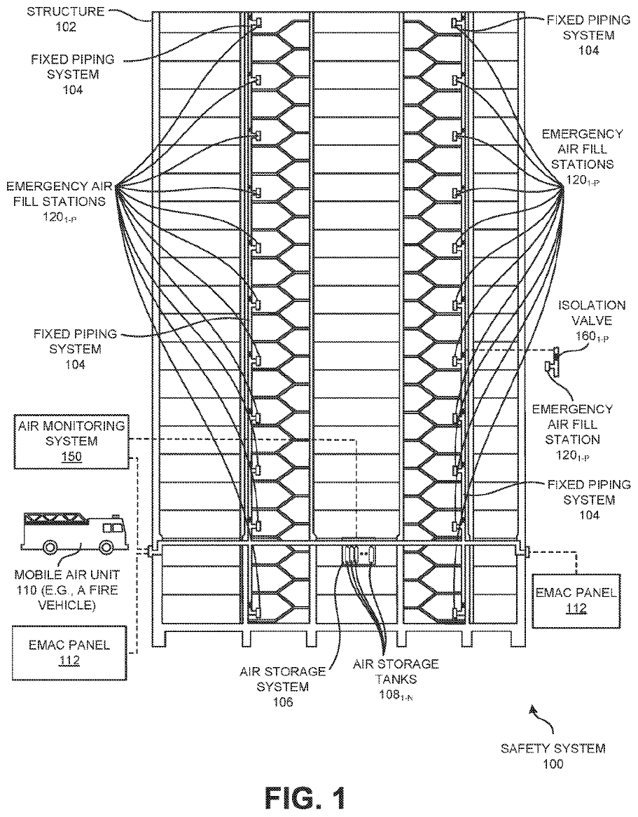

FIG. 1 shows a safety system 100 associated with a structure 102, according to one or more embodiments. In one or more embodiments, safety system 100 may be a Firefighter Air Replenishment System (FARS) to enable firefighters entering structure 102 in times of fire-related emergencies to gain access to breathable (e.g., human breathable) air in-house without the need of bringing in air bottles/cylinders to be transported up several flights of stairs of structure 102 or deep thereinto. In one or more embodiments, safety system 100 may supply air provided from a supply of air tanks (to be discussed) stored in structure 102. When a fire department vehicle arrives at structure 102 during an emergency, air supply typically may be provided through a source of air connected to said vehicle. In one or more embodiments, safety system 100 may enable firefighters to refill air bottles/cylinders thereof at emergency air fill stations (to be discussed) located throughout structure 102. Specifically, in some embodiments, firefighters may be able to fill air bottles/cylinders thereof at emergency air fill stations within structure 102 under full respiration in less than one to two minutes.

In one or more embodiments, structure 102 may encompass vertical building structures, horizontal building structures (e.g., shopping malls, hypermarts, extended shopping, storage and/or warehousing related structures), tunnels and marine craft (e.g., large marine vessels such as cruise ships, cargo ships, submarines and large naval craft, which may be “floating” versions of buildings and horizontal structures). In one or more embodiments, safety system 100 may include a fixed piping system 104 permanently installed within structure 102 serving as a constant source of replenishment of breathable air. Fixed piping system 104 may be regarded as being analogous to a water piping system within structure 102 or another structure analogous thereto for the sake of imaginative convenience.

As shown in FIG. 1, fixed piping system 104 may distribute air across floors/levels of structure 102. For the aforementioned purpose, fixed piping system 104 may distribute air from an air storage system 106 (e.g., within structure 102) including a number of air storage tanks 1081-N that serve as sources of pressurized air. Additionally, in one or more embodiments, fixed piping system 104 may interconnect with a mobile air unit 110 (e.g., a fire vehicle) through an External Mobile Air Connection (EMAC) panel 112.

In one or more embodiments, EMAC panel 112 may be a boxed structure (e.g., exterior to structure 102) to enable the interconnection between mobile air unit 110 and safety system 100. For example, mobile air unit 110 may include an on-board air compressor to store and replenish pressurized/compressed air in air bottles/cylinders (e.g., utilizable with Self-Contained Breathing Apparatuses (SCBAs) carried by firefighters). Mobile air unit 110 may also include other pieces of air supply/distribution equipment (e.g., piping and/or air cylinders/bottles) that may be able to leverage the sources of breathable air within safety system 100 through EMAC panel 112. Firefighters, for example, may be able to fill air into air bottles/cylinders (e.g., spare bottles, bottles requiring replenishment of breathable air) carried on mobile air unit 110 through safety system 100.

In FIG. 1, EMAC panel 112 is shown at two locations merely for the sake of illustrative convenience. In one or more embodiments, an air monitoring system 150 may be installed as part of safety system 100 to automatically track and monitor a parameter (e.g., pressure) and/or a quality (e.g., indicated by moisture levels, carbon monoxide levels) of breathable air within safety system 100. FIG. 1 shows air monitoring system 150 as communicatively coupled to air storage system 106 and EMAC panel 112 merely for the sake of example. It should be noted that EMAC panel 112 may be at a remote location associated with (e.g., internal to, external to) structure 102. In one or more embodiments, for monitoring the parameters and/or the quality of breathable air within safety system 100, air monitoring system 150 include appropriate sensors and circuitries therein. For example, a pressure sensor (not shown) within air monitoring system 150 may automatically sense and record the pressure of the breathable air of safety system 100. Said pressure sensor may communicate with an alarm system that is triggered when the sensed pressure is outside a safety range. Also, in one or more embodiments, air monitoring system 150 may automatically trigger a shutdown of breathable air distribution through safety system 100 in case of impurity/contaminant (e.g., carbon monoxide) detection therethrough yielding levels above a safety threshold.

In one or more embodiments, fixed piping system 104 may include pipes (e.g., constituted out of stainless steel tubing) that distribute breathable air to a number of emergency air fill stations 120_{1-P} within structure 102. In one example implementation, each emergency air fill station 120_{1-P} may be located at a specific level of structure 102. If structure 102 is regarded as a vertical building structure, an emergency air fill station 120_{1-P} may be located at each of a basement level, a first floor level, a second floor level and so on. For example, emergency air fill station 120_{1-P} may be located at the end of the flight of stairs that emergency fighting personnel (e.g., firefighting personnel) need to climb to reach a specific floor level within the vertical building structure.

In one or more embodiments, an emergency air fill station 120_{1-P} may be a static location within a level of structure 102 that provides emergency personnel (e.g., firefighters) with the ability to rapidly fill air bottles/cylinders (e.g., SCBA cylinders). In one or more embodiments, emergency air fill station 120_{1-P} may be an emergency air fill panel or a rupture containment air fill station. In one or more embodiments, proximate each emergency air fill station 120_{1-P} , safety system 100 may include an isolation valve 1601-p to isolate a corresponding emergency air fill station 120_{1-P} from a rest of safety system 100. For example, said isolation may be achieved through the manual turning of isolation valve 1601-p proximate the corresponding emergency air fill station 120_{1-P} or remotely from air monitoring system 150. In one example implementation, air monitoring system 150 may maintain breathable air supply to a subset of emergency air fill stations 120_{1-P} through control of a corresponding subset of isolation valves 1601-p and may isolate the other emergency air fill stations 120_{1-P} from the breathable air supply. It should be noted that configurations and components of safety system 100 may vary from the example safety system 100 of FIG. 1.

In one or more embodiments, elements of safety system 100 (e.g., EMAC panel 112, fixed piping system 104 at a basement level of structure 102 closest to EMAC panel 112) may be required to be communicatively coupled to one another in order that electrical connection and/or air connection therebetween is established. For the aforementioned purpose, in one or more embodiments, safety system 100 may have a distribution of raceways across levels thereof. A “raceway,” as discussed herein, may refer to an enclosed, flexible and dynamic conduit providing a physical pathway for electrical wiring and/or breathable air associated with (e.g., within) structure 102). In one or more embodiments, in the case of safety system 100 being a FARS, raceways may provide continuous pathways to electrically connect elements (e.g., a control panel within air storage system 106 and an emergency air fill station 120_{1-P} ) of said FARS to one another; again, raceways may also provide continuous pathways for an air connection between, say, fixed piping system 104 and EMAC panel 112. The raceway distribution discussed herein may apply to raceways within a ground level (i.e., buried below a ground surface) associated with structure 102. However, concepts discussed herein may also be applicable to raceways/raceway elements embedded within walls of structure 102.

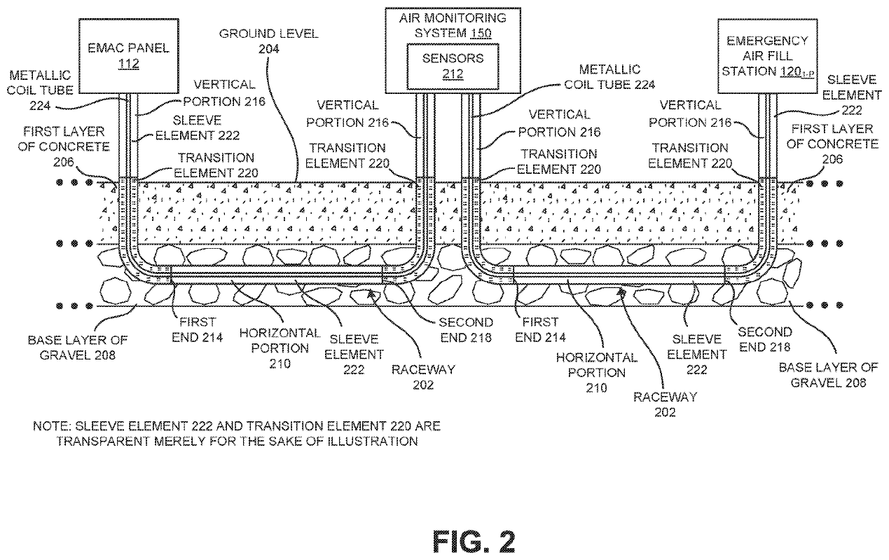

FIG. 2 shows a raceway 202 embedded within a ground level 204 associated with structure 102. according to one or more embodiments. In one or more embodiments, ground level 204 may be a basement ground level, a first floor ground level or even a ground level of a driveway associated with structure 102. Thus, in one or more embodiments, ground level 204 may physically be internal and/or external to structure 102 (e.g., a building); in the solely external case, ground level 204 may be in proximity (e.g., the driveway) to structure 102. Other examples of ground level 204 are within the scope of the exemplary embodiments discussed herein.

FIG. 2 shows ground level 204 as a layer of concrete 206 directly on top of a base layer of gravel 208 for example purposes. FIG. 2 shows raceway 202 with a horizontal portion 210 thereof completely embedded within base layer of gravel 208 below layer of concrete 206. In the example discussed above, as ground level 204 may subsume a surface external to structure 102 and in proximity thereof and EMAC panel 112 may be provided on said surface, raceway 202 may need to have a pathway to electrically connect components of EMAC panel 112 to, say, air monitoring system 150 that senses a quality (e.g., moisture levels, carbon monoxide levels) of breathable air within safety system 100 utilizing sensors embedded therein. FIG. 2 shows air monitoring system 150 with sensors 212 included therein, according to one or more embodiments. In the example, both EMAC panel 112 and air monitoring system 150 may include modules with electrical and mechanical components; even electro-mechanical, hydraulic, pneumatic and/or other components may be part of EMAC panel 112 and/or air monitoring system 150. Both EMAC panel 112 and air monitoring system 150 may be disposed above ground level 204. In the case of air monitoring system 150, ground level 204 may subsume some ground surface within structure 102.

In one or more embodiments, when electrical connection between EMAC panel 112 and air monitoring system 150 is to be accomplished through raceway 202, design considerations may involve the transition between horizontal portion 210 of raceway 202 at a first end 214 thereof and a vertical portion 216 thereof that couples to EMAC panel 112 and the transition between horizontal portion 210 of raceway 202 at a second end 218 thereof that couples to air monitoring system 150. In one or more embodiments, once these transitions are accomplished, EMAC panel 112 and air monitoring system 150 may be electrically connected to one another based on the continuous pathway therefor provided by raceway 202.

For example, readings related to the quality of breathable air within safety system 150 that is sensed through sensors 212 of air monitoring system 150 may also be reflected in EMAC panel 112. The electrical connection between EMAC panel 112 and air monitoring system 150 may, thus, be required. FIG. 2 shows the same raceway 202 with horizontal portion 210 and vertical portion 216 providing a continuous pathway (e.g., for electrical/air connection) between an emergency air fill station 120_{1-P} (e.g., an emergency air fill panel or a rupture containment air fill station) within structure 102 disposed above ground level 204 and air monitoring system 150; emergency air fill station 120_{1-P} may also be internal to structure 102 at a same level as air monitoring system 150 and/or EMAC panel 112. For example, the quality of breathable air accessible through emergency air fill station 120_{1-P} may be monitored through sensors 212 of air monitoring system 150. The electrical connection discussed herein may enable data communication between air monitoring system 150 and emergency air fill station 120_{1-P} (e.g., may include electrical components). The status of the quality of breathable air within safety system 100 may also be communicated to EMAC panel 112 by way of air monitoring system 150.

It is obvious that EMAC panel 112, air monitoring system 150 and emergency air fill station 120_{1-P} have been shown in FIG. 2 merely for example purposes. Concepts discussed herein with regard to raceway 202 may enable establishment of electrical connection(s) between any set of elements (e.g., including computing/data processing devices) of safety system 100 and/or one of the elements of safety system 100 with EMAC panel 112, air monitoring system 150 and/or emergency air fill station 120_{1-P} . Raceway 202 has been shown in FIG. 2 twice with the same dimensions merely for example purposes. It should be noted that one raceway 202 of FIG. 2 may differ in dimensional parameters and/or other parameters from the other raceway 202 while retaining the concepts discussed herein as common characteristics therebetween.

Further, it should be noted that air connections between elements of safety system 100 may also established utilizing the direct pathway therefor provided by raceway 202 of FIG. 2. In one or more embodiments, as shown in FIG. 2, the transition between horizontal portion 210 and vertical portion 216 of raceway 202 may be accomplished through a transition element 220 coupling horizontal portion 210 to vertical portion 216 to complete the pathways for an electrical and/or an air connection between EMAC panel 112 and air monitoring system 150 and the electrical and/or air connection between air monitoring system 150 and emergency air fill station 120_{1-P} . Transition element 220 will be discussed in detail below. In one or more embodiments, as shown in FIG. 2, horizontal portion 210 and/or vertical portion 216 may be constituted by a sleeve element 222 (e.g., cylindrical in shape) including a metallic coil tube 224 (e.g., including a passage for air and/or electrical wiring) passing therethrough. In one example implementation, sleeve element 222 may be a Polyvinyl Chloride (PVC) tube as per Schedule 80 having an outer diameter of 2 inches. Said PVC tube may be under layer of concrete 206 (e.g., concrete slab) and embedded within base layer of gravel 208.

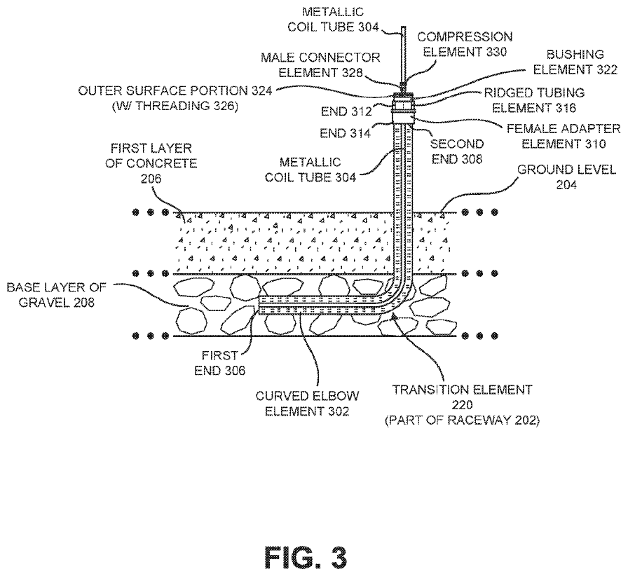

In the above example implementation, metallic coil tube 224 may be made of stainless steel and may have an outer diameter of 0.5 inches. In one or more embodiments, transition element 220 may render it possible to complete pathways for establishing air and/or electrical connections utilizing a standard set of tubes and/or standard configuration thereof without a need to curve said tubes and/or manufacture them in a non-standard way that imparts instability thereto. FIG. 3 shows transition element 220 of FIG. 2 in detail, according to one or more embodiments. In one or more embodiments, as shown in FIGS. 2-3, transition element 220 may be an elbow tubing connector element that is curved is shape. In one or more embodiments, transition element 220 may include an curved elbow element 302 that is made of a metallic, a coated metallic or a non-metallic material. In an example preferred implementation, curved elbow element 302 may have a 90° elbow with an elbow radius of at least 12 inches (e.g., a range between 12-18 inches).

In one or more embodiments, curved elbow element 302 may carry a metallic coil tube 304 (e.g., curved) therethrough from a first end 306 to a second end 308 thereof. In one or more embodiments, metallic coil tube 304 may be the same as metallic coil tube 224. In one or more embodiments, metallic coil tube 304 and metallic coil tube 224 may form a continuous, single metallic coil tube. All reasonable variations are within the scope of the exemplary embodiments discussed herein.

At first end 306 and/or second end 308. in one or more embodiments, a female adapter element 310 may be provided and/or directly coupled thereto. FIG. 3 shows female adapter element 310 solely at second end 308 for the sake of illustrative convenience. In one or more embodiments, first end 306 or second end 308 may be received through female adapter element 310. In an example preferred implementation. female adapter element 310 may be a PVC tube as per Schedule 80 with an outer diameter of 2 inches. In one or more embodiments, at an end 312 of female adapter element 310 that is away from an end 314 thereof through which first end 306 or second end 308 of curved elbow element 302 is first received, a ridged tubing element 316 may be provided or formed therewith. In one or more embodiments, ridged tubing element 316 may enable female adapter element 310 to be gripped by a user.

In one or more embodiments, a bushing element 322 may be directly coupled to ridged tubing element 316 to reduce friction between rotatable tubing elements. In one preferred implementation, bushing element 322 may be a PVC bushing with an outer diameter of 2 inches and an inner diameter of 0.5 inches. In one or more embodiments, as shown in FIG. 3, at least an outer surface portion 324 of bushing element 322 emerging out of ridged tubing element 316 may be threaded (see, e.g., threading 326 in FIG. 3) to enable coupling of a tube 350 (e.g., vertical portion 216 of FIG. 2) thereto. In one or more embodiments, a male connector element 328 may be bored into bushing element 322.

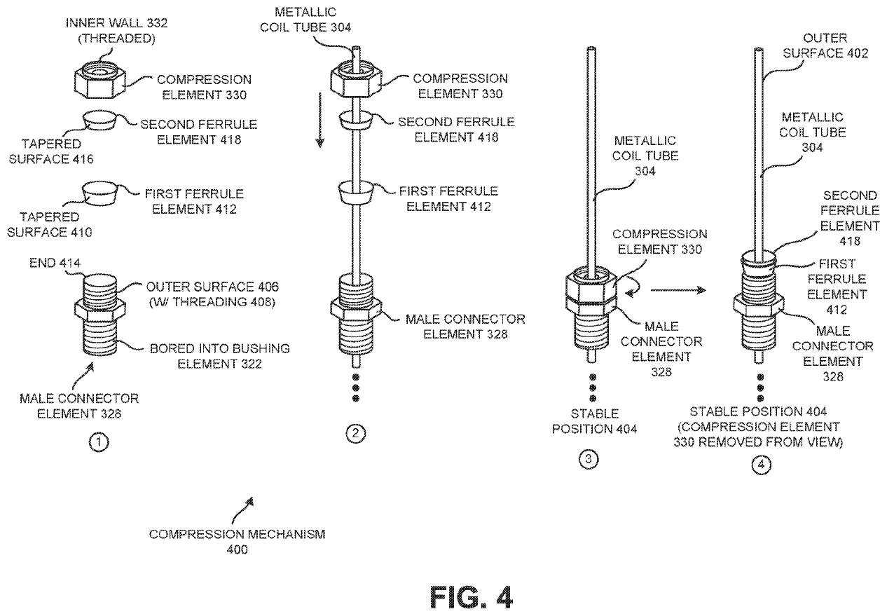

For the abovementioned purpose, in one or more embodiments, an inside wall of bushing element 322 may be threaded and male connector element 328 screwed thereinto. In one or more embodiments, metallic coil tube 304 may be passed through (or received through) inner walls/diameters (e.g., 0.5 inches) of bushing element 322 and male connector element 328 and an outer surface of metallic coil tube 304 sealed based on a compression mechanism (to be discussed with regard to FIG. 4) involving a compression element 330 (e.g., a compression nut).

FIG. 4 shows a compression mechanism 400 (e.g., compression based fitting) based on which an outer surface 402 of metallic coil tube 304 of FIG. 3 is sealed into a stable position 404 thereof, according to one or more embodiments. As seen in FIG. 4, compression mechanism 400 may involve male connector element 328 coupled to (or bored into, screwed into) bushing element 322. In one or more embodiments, an outer surface 406 of male connector element 328 protruding out of bushing element 322 may be threaded (see, e.g., threading 408 in FIG. 4). In one or more embodiments, a tapered surface 410 of a first ferrule element 412 (e.g., a front ferrule) may be received within male connector element 328 from an end 414 thereof at which threading 408 starts; said first ferrule element 412 may encircle metallic coil tube 304 protruding from male connector element 328. In one or more embodiments, a tapered surface 416 of a second ferrule element 418 (e.g., a back ferrule) may be received within compression element 330; metallic coil tube 304 may also be received through second ferrule element 418 and compression element 330.

In one example implementation, compression element 330 may be a compression nut and an inner wall 332 thereof may be threaded. In one or more embodiments, turning compression element 330 over threading 408 of male connector element 328 creates a force that causes first ferrule element 412 to proceed to seal metallic coil tube 304 therewithin. In one or more embodiments, second ferrule element 418 may additionally secure metallic coil tube 304 within first ferrule element 412 by generating an axial force during the turning of compression element 330 that moves first ferrule element 412 within male connector element 328 and also applies a radial grip on metallic coil tube 304. In one or more embodiments, after turning compression element 330 over threading 408 to lock compression element 330 thereonto, the radial grip on metallic coil tube 304 exerted by second ferrule element 418 and the seal on metallic coil tube 304 applied by first ferrule element 412 may seal outer surface 402 of metallic coil tube 304 into stable position 404 thereof.

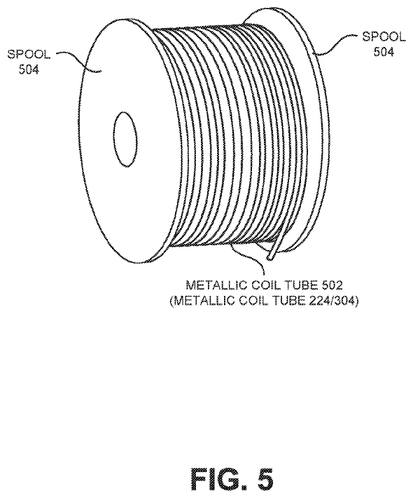

While exemplary embodiments discussed in FIG. 4 show two ferrule elements, it may also be possible to realize advantages associated with the concepts discussed herein based on a single or more than two ferrule elements. Also, FIG. 2 does not show compression mechanism 400 and female adapter element 310 for the sake of illustrative clarity; these have been clearly explained in FIGS. 3-4 and it is easy to see how they may be portable to raceway 202 in FIG. 2. Further, it should be noted that metallic coil tube 224 and/or metallic coil tube 304 may be long tube portions or bits of tube portions that create the pathways discussed above. In one or more embodiments, metallic coil tube 304/224 may be flexible enough to be conveniently bent in accordance with curved elbow element 302. FIG. 5 shows metallic coil tube 502 wound onto a spool 504, according to one or more embodiments. In one or more embodiments, metallic coil tube 502 may be cut or utilized as is as metallic coil tube 304 and/or metallic coil tube 224.

It must be noted that raceways (e.g., analogous to raceway 202) may be generated to extend to long distances and to transition to perpendicular directions based on the utilization of curved elbow element 302, female adapter element 310 and metallic coil tube 502. Exemplary embodiments discussed herein may meet all regulatory standards and/or requirements and may withstand harsh environments associated with ground level 204. For example, curved elbow element 302 may pass through layer of concrete 206 from base layer of gravel 208 in FIG. 2.

In one or more embodiments, as components of raceway 202 including horizontal portion 210, vertical portion 216, curved elbow portion 302 and female adapter element 310 may be fire rated, the enclosure provided to metallic coil tube 304/224 may also be fire rated and physically isolated based on embedding of raceway 202 or a portion thereof below layer of concrete 206. In one or more embodiments, as no joints involving metallic coil tube 304/224 are formed, a seamless tubing may be achieved during construction of safety system 100 (e.g., a FARS). Last but not the least, FIG. 2 may be envisioned without vertical portion 216 of raceway 202. In one or more embodiments, metallic coil tube 304/224 may merely emerge out of transition element 220 (connected to horizontal portion 210) to directly connect to elements (e.g., EMAC panel 112, air monitoring system 150, emergency air fill station 120_{1-P} ) of safety system 100 (e.g., a FARS). All reasonable variations are within the scope of the exemplary embodiments discussed herein.

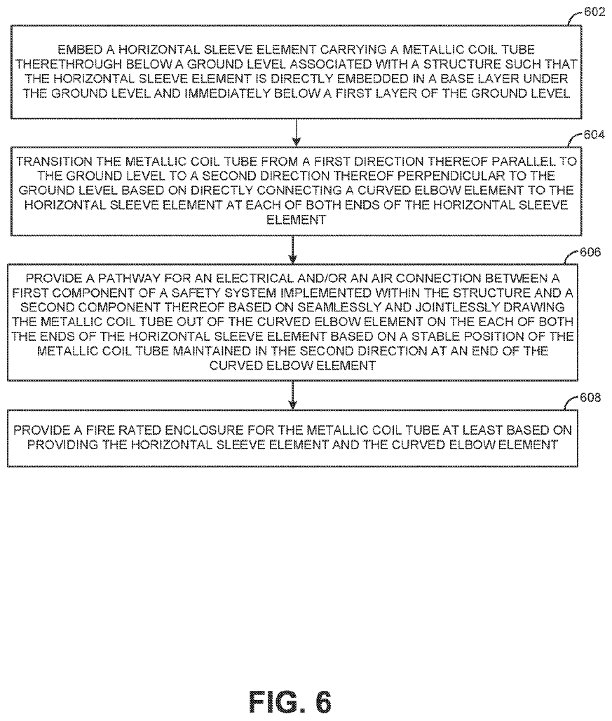

FIG. 6 shows a process flow diagram detailing the operations involved in realizing an in-ground raceway (e.g., raceway 202) of a safety system (e.g., safety system 100) associated with a structure (e.g., structure 102) with one or more fire rated component(s) to provide physical isolation and to seamlessly and jointlessly transition a metallic coil tube (e.g., metallic coil tube 224/304/502) across perpendicular directions, according to one or more embodiments. In one or more embodiments, operation 602 may involve embedding a horizontal sleeve element (e.g., sleeve element 222) carrying the metallic coil tube therethrough below a ground level (e.g., ground level 204) associated with the structure (e.g., structure 102) such that the horizontal sleeve element is directly embedded in a base layer (e.g., base layer of gravel 208) under the ground level and immediately below a first layer (e.g., first layer of concrete 206) of the ground level.

In one or more embodiments, operation 604 may involve transitioning the metallic coil tube from a first direction thereof parallel to the ground level to a second direction thereof perpendicular to the ground level based on directly connecting a curved elbow element (e.g., curved elbow element 302) to the horizontal sleeve element at each of both ends of the horizontal sleeve element. In one or more embodiments, the transition may be in accordance with providing a female adapter element (e.g., female adapter element 310) at an end (e.g., second end 308) of the curved elbow element along the second direction by way of receiving the end of the curved elbow element directly within the female adapter element, providing a bushing element (e.g., bushing element 322) directly coupled to the female adapter element, boring a male connector element (e.g., male connector element 328) into the bushing element, and passing the metallic coil tube through the male connector element and the bushing element.

In one or more embodiments, the transition may also include, based on compression based fitting (e.g., compression mechanism 400), sealing the metallic coil tube to a stable position thereof within the male connector element proximate the end of the curved elbow element in accordance with one or more ferrule element(s) (e.g., first ferrule element 412, second ferrule element 418) encircling the metallic coil tube gripping an outer surface (e.g., outer surface 402) of the metallic coil tube as a result of a compression element (e.g., compression element 330) also receiving the metallic coil tube therethrough locking on to the male connector element.

In one or more embodiments, operation 606 may involve providing a pathway for an electrical and/or a breathable air connection between a first component of the safety system implemented within the structure and a second component thereof based on seamlessly and jointlessly drawing the metallic coil tube out of the curved elbow element on the each of both the ends of the horizontal sleeve element based on the stable position of the metallic coil tube maintained in the second direction. In one or more embodiments, operation 608 may then involve providing a fire rated enclosure for the metallic coil tube at least based on providing the horizontal sleeve element, the curved elbow element and the female adapter element therefor.

Although the present embodiments have been described with reference to specific example embodiments, it will be evident that various modifications and changes may be made to these embodiments without departing from the broader spirit and scope of the various embodiments.

A number of embodiments have been described. Nevertheless, it will be understood that various modifications may be made without departing from the spirit and scope of the claimed invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

The structures and modules in the figures may be shown as distinct and communicating with only a few specific structures and not others. The structures may be merged with each other, may perform overlapping functions, and may communicate with other structures not shown to be connected in the figures. Accordingly. the specification and/or drawings may be regarded in an illustrative rather than a restrictive sense.

What is claimed is:

1. A raceway comprising:
a horizontal sleeve element carrying a metallic coil tube therethrough below a ground level associated with a structure such that the horizontal sleeve element is directly embedded in a base layer under the ground level and immediately below a first layer of the ground level;
a curved elbow element directly connected to the horizontal sleeve element at each of both ends of the horizontal sleeve element to transition the metallic coil tube from a first direction thereof parallel to the ground level to a second direction thereof perpendicular to the ground level;
a female adapter element provided at an end of the curved elbow element along the second direction to receive the end of the curved elbow element directly therewithin;
a bushing element directly connected to the female adapter element; and
a male connector element bored into the bushing element,
wherein the metallic coil tube passes through the male connector element and the bushing element,
wherein, in accordance with compression based fitting, the metallic coil tube is sealed to a stable position thereof within the male connector element proximate the end of the curved elbow element in accordance with at least one ferrule element encircling the metallic coil tube gripping an outer surface of the metallic coil tube as a result of a compression element also receiving the metallic coil tube therethrough locking on to the male connector element,
wherein a pathway for at least one of: an electrical and a breathable air connection between a first component of a safety system implemented within the structure and a second component thereof is established based on seamlessly and jointlessly drawing the metallic coil tube out of the curved elbow element on the each of both the ends of the horizontal sleeve element based on the stable position of the metallic coil tube maintained in the second direction, and
wherein at least the horizontal sleeve element, the curved elbow element and the female adapter element create a fire rated enclosure for the metallic coil tube.

2. The raceway of claim 1, wherein the horizontal sleeve element is a Polyvinyl Chloride (PVC) tube.

3. The raceway of claim 1, wherein at least one of:
the metallic coil tube is made of stainless steel,
the horizontal sleeve element is below the ground level, with the ground level subsuming a ground surface at least one of: internal to the structure and external thereto,
the horizontal sleeve element is below the ground level, with the ground level being a floor level within the structure, and
the horizontal sleeve element is below the ground level associated with the structure that has a Firefighter Air Replenishment System (FARS) implemented therein as the safety system.

4. The raceway of claim 1, wherein the curved elbow element is made of one of: a metallic, a coated metallic and a non-metallic material.

5. The raceway of claim 4, wherein the curved elbow element has a 90° elbow with an elbow radius of at least 12 inches.

6. The raceway of claim 1, wherein the horizontal sleeve element is below the ground level, with the first layer of the ground level being a layer of concrete.

7. The raceway of claim 6, wherein the horizontal sleeve element is below the ground level, with the base layer under the ground level being a layer of gravel.

8. A raceway system associated with a structure, comprising:
a first component of a safety system implemented in the structure;
a second component of the safety system implemented in the structure; and
a raceway comprising:
a horizontal sleeve element carrying a metallic coil tube therethrough below a ground level associated with the structure such that the horizontal sleeve element is directly embedded in a base layer under the ground level and immediately below a first layer of the ground level;
a curved elbow element directly connected to the horizontal sleeve element at each of both ends of the horizontal sleeve element to transition the metallic coil tube from a first direction thereof parallel to the ground level to a second direction thereof perpendicular to the ground level;
a female adapter element provided at an end of the curved elbow element along the second direction to receive the end of the curved elbow element directly therewithin;
a bushing element directly connected to the female adapter element; and
a male connector element bored into the bushing element,
wherein the metallic coil tube passes through the male connector element and the bushing element,
wherein, in accordance with compression based fitting, the metallic coil tube is sealed to a stable position thereof within the male connector element proximate the end of the curved elbow element in accordance with at least one ferrule element encircling the metallic coil tube gripping an outer surface of the metallic coil tube as a result of a compression element also receiving the metallic coil tube therethrough locking on to the male connector element,
wherein a pathway for at least one of: an electrical and a breathable air connection between the first component of the safety system and the second component thereof is established based on seamlessly and jointlessly drawing the metallic coil tube out of the curved elbow element on the each of both the ends of the horizontal sleeve element based on the stable position of the metallic coil tube maintained in the second direction, and
wherein at least the horizontal sleeve element, the curved elbow element and the female adapter element create a fire rated enclosure for the metallic coil tube.

9. The raceway system of claim 8, wherein the horizontal sleeve element of the raceway is a PVC tube.

10. The raceway system of claim 8, wherein at least one of:
the metallic coil tube is made of stainless steel,
the horizontal sleeve element of the raceway is below the ground level, with the ground level subsuming a ground surface at least one of: internal to the structure and external thereto,
the horizontal sleeve element of the raceway is below the ground level, with the ground level being a floor level within the structure, and
the horizontal sleeve element of the raceway is below the ground level associated with the structure that has a FARS implemented therein as the safety system.

11. The raceway system of claim 8, wherein the curved elbow element of the raceway is made of one of: a metallic, a coated metallic and a non-metallic material.

12. The raceway system of claim 11, wherein the curved elbow element of the raceway has a 90° elbow with an elbow radius of at least 12 inches.

13. The raceway system of claim 8, wherein the horizontal sleeve element of the raceway is below the ground level, with the first layer of the ground level being a layer of concrete.

14. The raceway system of claim 13, wherein the horizontal sleeve element of the raceway is below the ground level, with the base layer under the ground level being a layer of gravel.

15. A method comprising:
embedding a horizontal sleeve element carrying a metallic coil tube therethrough below a ground level associated with a structure such that the horizontal sleeve element is directly embedded in a base layer under the ground level and immediately below a first layer of the ground level;
transitioning the metallic coil tube from a first direction thereof parallel to the ground level to a second direction thereof perpendicular to the ground level based on directly connecting a curved elbow element to the horizontal sleeve element at each of both ends of the horizontal sleeve element in accordance with:
providing a female adapter element at an end of the curved elbow element along the second direction by way of receiving the end of the curved elbow element directly within the female adapter element;
providing a bushing element directly coupled to the female adapter element;
boring a male connector element into the bushing element;
passing the metallic coil tube through the male connector element and the bushing element; and
based on compression based fitting, sealing the metallic coil tube to a stable position thereof within the male connector element proximate the end of the curved elbow element in accordance with at least one ferrule element encircling the metallic coil tube gripping an outer surface of the metallic coil tube as a result of a compression element also receiving the metallic coil tube therethrough locking on to the male connector element;
providing a pathway for at least one of: an electrical and a breathable air connection between a first component of a safety system implemented within the structure and a second component thereof based on seamlessly and jointlessly drawing the metallic coil tube out of the curved elbow element on the each of both the ends of the horizontal sleeve element based on the stable position of the metallic coil tube maintained in the second direction; and
providing a fire rated enclosure for the metallic coil tube at least based on providing the horizontal sleeve element, the curved elbow element and the female adapter element therefor.

16. The method of claim 15, comprising at least one of:
the horizontal sleeve element being a PVC tube;
the metallic coil tube being made of stainless steel;
the horizontal sleeve element being below the ground level, with the ground level subsuming a ground surface at least one of: internal to the structure and external thereto;
the horizontal sleeve element being below the ground level, with the ground level being a floor level within the structure; and
the horizontal sleeve element being below the ground level associated with the structure that has a FARS implemented therein as the safety system.

17. The method of claim 15, comprising the curved elbow element being made of one of: a metallic, a coated metallic and a non-metallic material.

18. The method of claim 17, comprising the curved elbow element having a 90° elbow with an elbow radius of at least 12 inches.

19. The method of claim 15, comprising the horizontal sleeve element being below the ground level, with the first layer of the ground level being a layer of concrete.

20. The method of claim 19, comprising the horizontal sleeve element being below the ground level, with the base layer under the ground level being a layer of gravel.
